(19) United States
(12) Patent Application Publication
(10) Pub. No.: US 2008/0069995 A1
(43) Pub. Date: Mar. 20, 2008

(54) Thermoplastic material for producing flexible tubular articles having at least one weld

(76) Inventors: Gery Bernard Marie Cornil Dambricourt, Escoutoux (FR); Alain Bourdier, Crevant Laveine (FR)

Correspondence Address: MILES & STOCKBRIDGE PC, 1751 PINNACLE DRIVE, SUITE 500, MCLEAN, VA, 22102-3833, US

(21) Appl. No.: 11/902,002

(22) Filed: Sep. 18, 2007

(30) Foreign Application Priority Data
Sep. 19, 2006 (FR) 06/08200

(51) Int. Cl. C08L 23/00; B29D 23/00

(52) U.S. Cl. 428/36.9; 525/240

(57) ABSTRACT

The invention relates to a flexible tube and a thermoplastic material utilisable for producing by injection the flexible tubes which has at least one weld, the thermoplastic material is constituted by at least one heterophasic polymer, having a flexure modulus of 100 to 600 MPa according to the standard ISO 178, comprising a polymer matrix based on polypropylene and/or a copolymer of propylene, and nodules of ethylene-propylene rubber, characterised in that it also comprises a copolymer of propylene and butene, and optionally another α-olefin in C₂-C₈.

The present invention generally relates to materials of polymer type utilised for making packaging in the form of flexible tubes having at least one weld, which are traditionally utilised for packaging products such as dentifrices, dietary or cosmetic creams, adhesives or mastics.

In the production of flexible tubes by an injection process, when the wall of the tube is made of a polymer or a mixture of polymer based on polypropylene, heterophasic polymers are generally used comprising a polymer matrix based on polypropylene and/or a copolymer of propylene, and nodules of ethylene-propylene rubber (or EPR). To obtain the flexibleness required for utilisation of flexible tubes, and considering the thickness of the wall of the tubes made by injection, polypropylenes are used which have a flexure modulus varying from 100 to 600 MPa according to the standard ISO 178, therefore charges of EPR nodules.

However, the presence of nodules EPR creates a risk of separation of the phases during welding of the wall of the tube. This separation of phases is embodied by the appearance of whitening at the level of the welded zone, as well as a decrease in the resistance of the weld in this zone. This results in poor weld quality.

The aim of the present invention is therefore to propose a thermoplastic material utilisable for production by injection of flexible tubes to eliminate these drawbacks.

The tubes made of the material of the invention can be welded after filling along the production lines equipped with a welding process known as <<hot-air nozzle >> process, which is currently a widespread process.

Surprisingly, the applicant discovered that the mixture of such a heterophasic polymer with a copolymer of polypropylene and butene, and optionally another α-olefin in C₂-C₈, produces a material which significantly improves the behaviour of the weld of the wall of a tube made of this material.

More particularly, the applicant was surprised to see that the presence of a copolymer of polypropylene and butene in the composition of a thermoplastic material containing a heterophasic polymer of the type previously cited effectively limits separation of the phases in the material, by levelling the differences in behaviour of the base matrix and the nodules during melting and, more particularly when solidification occurs during welding of the wall.

The object of the present invention is therefore to provide a thermoplastic material utilisable for the production by injection of flexible tubes having at least one weld, this material comprising at least one heterophasic polymer having a flexure modulus according to the standard ISO 178 of 100 to 600 MPa and comprising a polymer matrix based on polypropylene and/or a copolymer of propylene, and nodules of ethylene-propylene rubber, characterised in that it also comprises a copolymer of propylene and butene, and optionally of another α-olefin in C₂-C₈.

The thermoplastic material according to the invention has specific thermal properties which can be revealed by differential scanning calorimetry (or DSC). In particular, the DSC analysis of the thermoplastic material according to the invention reveals an endothermic event corresponding to melting/softening which occurs at a temperature between 130 and 150° C., while this phenomenon occurs at a much higher temperature, between 162 and 170° C., in polypropylene. Now, this endothermic event takes place, for the thermoplastic material of the invention, within the range of variation of the melting temperature of the EPR, also between 130 and 150° C. Due to this, the differences in behaviour of the thermoplastic material according to the invention are highly attenuated during the welding operation, and more particularly in the solidification phase, thus limiting the risk of separation of the different phases of the thermoplastic material.

By way of heterophasic polymers having a flexure modulus of 100 to 600 MPa utilisable according to the present invention, particular examples are statistic heterophasic copolymers of propylene-ethylene, such as for example the product marketed by the company BOREALIS under the brand name Borsoft™ SF 203 CF.

By way of copolymer of propylene-butene utilisable according to the present invention, a particular example is the product marketed by the company Basell under the brand name Adsyl 5 C 30 F

The copolymer of propylene-butene can be a terpolymer of propylene-ethylene-butene.

By way of terpolymer of propylene-ethylene-butene according to the present invention, a particular example is the product marketed by the company BOREALIS under the brand name Borseal™ TD218BF.

The proportion of heterophasic polymer and copolymer of propylene-butene in the thermoplastic material according to the invention has an influence on the behaviour of the weld and the flexibleness of the wall of the tubes made with the thermoplastic material according to the invention.

Advantageously, the copolymer of propylene and butene represents from 10% to 50% by weight of the material of the invention. It is preferable that the proportion of the copolymer of propylene and butene in the thermoplastic material according to the invention is less than 50% by weight to conserve the degree of flexibleness required.

If the copolymer of propylene and butene represents at least 15% by weight of thermoplastic material, a clear improvement is observed in the behaviour of the latter during a thermal welding treatment. To attain an ideal behaviour of the thermoplastic material according to the invention during welding, it is preferable that the proportion of copolymer of propylene and butene is between 15 and 33%, and better still, of the order of 20% by weight of this material.

According to a particularly advantageous embodiment, the thermoplastic material of the present invention comprises a mixture of two heterophasic polymers each comprising a polymer matrix based on polypropylene and/or a copolymer of propylene, and nodules of ethylene-propylene rubber:
the first heterophasic polymer having a flexure modulus of at least 300 MPa, preferably of the order of 400 MPa, and
the second heterophasic polymer having a flexure modulus of 70 MPa to 100 MPa, preferably around 80 MPa.

By way of second heterophasic polymer having a flexure modulus of 70 MPa to 100. MPa, thermoplastic polyolefins marketed by the company Basell under the brand names Hifax CA 60 A and Adflex X 100G can especially be cited.

By way of advantage, the first heterophasic polymer occurs in the thermoplastic material according to the present invention at a rate of 40 to 80% by weight, preferably at a rate of around 55% by weight of thermoplastic material, whereas the second heterophasic polymer occurs at a rate of 0 to 40% by weight, and preferably at a rate of around 25% by weight of thermoplastic material.

Finally, another object of the present invention is a flexible tube made of a thermoplastic material according to the invention. The flexible tube according to the invention can especially be utilised for packaging products such as cosmetic creams, dentifrices, dietary creams, adhesives, etc.

The flexible tube according to the invention can be made by the production process described in FR 2850363 and FR 2850362. The flexible tube according to the invention can advantageously exhibit a structure in keeping with those described in FR2850363 and FR2850362.

The present invention will be better illustrated by way of the following comparative examples. The quantities are indicated in percentages by weight, unless otherwise specified.

### EXAMPLES

Products
polyethylene marketed by the company DOW under the brand name DOWLEX 2035.
copolymer Ethylene Ethyl Acrylate marketed by the company DuPont under the brand name Elvaloy® 2715 AC,
polybutene-1 marketed by the company BASELL under the brand name DP 8510,
heterophasic copolymer of propylene-ethylene marketed by the company BOREALIS under the brand name Borsoft™ SF203CF,
thermoplastic polyolefin (heterophasic polypropylene) marketed by the company Basell under the brand name Hifax CA 60 A,
thermoplastic polyolefin (heterophasic polypropylene) marketed by the company Basell under the brand name Adflex X 100G,
copolymer of propylene-butene marketed by the company Basell under the brand name Adsyl 5 C 30 F,
terpolymer of propylene-ethylene-butene marketed by the company BOREALIS under the brand name Borseal™ TD218BF.

Preparation of Samples:

Five samples of check tubes T1 to T5 were prepared, which are made of a material of the prior art, whereof the weight composition is indicated in Table 1:

TABLE 1

Composition

| Samples | Products | Quantity (%) |
|---|---|---|
| T1 | polyethylene | 100 |
| T2 | Borsoft ™ SF203 CF | 67 |
| | Hifax CA 60 A | 33 |
| T3 | Borsoft ™ SF203 CF | 100 |
| T4 | Borsoft ™ SF203 CF | 80 |
| | Elvaloy ® 2715 AC | 20 |
| T5 | Borsoft^{M} SF203 CF | 90 |
| | polybutene-1 DP 8510 | 10 |

Three tubes E1 to E3 according to the invention were also prepared, all of which have a weld identical to that of samples T1 to T5, and which are made of a thermoplastic material according to the invention, whereof the weight composition is indicated in Table 2

TABLE 2

Composition

| Samples | Products | Quantity (%) |
|---|---|---|
| E1 | Borsoft ™ SF203CF | 80 |
| | Adsyl 5C30CF | 20 |
| E2 | Borsoft ™ SF203CF | 80 |
| | Borseal ™ TD218BF | 20 |
| E3 | Borsoft ™ SF203CF | 53.6 |
| | Hifax CA 60 A | 26.4 |
| | Adsyl | 20 |

The tubes T1 to T5 and E1 to E3 are formed by moulding according to the injection process. They are then welded, on a production machine equipped with the process known as <<hot-air nozzle >>, marketed by the companies Kalix or Norden. The tightness of the tubes was previously guaranteed by stopping their orifice.

A weld resistance test was performed on the samples T1 to T5 and E1 to E3.

This test consists of subjecting the weld of a tube to an inner pressure varying from 2 to 5 bars (±0, 2 bars) for 10 seconds (±1 second), to determine, for each of the products tested, whether the weld resists or not the pressure exerted on it. If the weld resists the pressure exerted, <<yes >> is indicated in Table 3 showing the results of this test. If not, <<no >> is indicated (see below in the paragraph relative to the results).

Apparatus marketed by the company JACOMEX, under the brand name <<tube crusher apparatus >> is utilised to perform this test.

Results:

The behaviour of the samples T1 to T5 and E1 to E3 during the weld resistance test was evaluated for pressures ranging from 2 to 5 bars, over an interval of 10 seconds.

The results are presented in Table 3.

TABLE 3

| | Pressure | | | |
|---|---|---|---|---|
| Samples | 2 bars | 3 bars | 3.5 bars | 4 bars |
| T1 | YES | YES | NOT TESTED | YES |
| T2 | YES | NO | NO | NO |
| T3 | YES | NO | NOT TESTED | NO |
| T4 | NO | NO | NOT TESTED | NO |
| T5 | YES | NO | NOT TESTED | NO |
| E1 | YES | YES | NOT TESTED | YES |
| E2 | YES | YES | NOT TESTED | NOT TESTED |
| E3 | NOT | NOT TESTED | YES | NOT TESTED |
| | TESTED | | | |

These results show that the weld of the samples according to the invention (E1, E2 and E3) resists a pressure of 3 bars, as is the case for the samples of pure polyethylene (T1) which is the reference material par excellence in terms of resistance to the weld.

When the tubes are not made of a thermoplastic material according to the invention, the weld cannot resist pressure of 3 bars (T2, T3 and T5), or even less (2 bars for T4).

1. A thermoplastic material for producing flexible tubes having at least one weld by injection, said material constituted by at least one heterophasic polymer, having a flexure modulus of 100 to 600 MPa according to the standard ISO 178, comprising a polymer matrix based on polypropylene and/or a copolymer of propylene, and nodules of ethylene-propylene rubber, and a copolymer of propylene and butene, and optionally another α-olefin in C₂-C₈.

2. The thermoplastic material as claimed in claim 1, characterised in that the copolymer of propylene and butene is a terpolymer of propylene-ethylene-butene.

3. The thermoplastic material as claimed in claim 1 characterised in that the copolymer of propylene and butene represents from 10% to 50% by weight of the thermoplastic material.

4. The thermoplastic material as claimed in claim 3, characterised in that the copolymer of propylene and butene represents 15 to 33%, and preferably around 20% by weight of thermoplastic material.

5. The thermoplastic material as claimed claim 1, characterised in that it comprises a mixture of a first and a second heterophasic polymers comprising each a polymer matrix based on polypropylene and/or a copolymer of propylene, and nodules of ethylene-propylene rubber:
the first heterophasic polymer having a flexure modulus of at least 300 MPa, preferably of the order of 400 MPa,
the second heterophasic polymer having a flexure modulus of 70 Pa to 100 MPa, preferably around 80 MPa.

6. The thermoplastic material as claimed claim 5, characterised in that:
the first heterophasic polymer represents 40 to 80% by weight of the thermoplastic material, and
the second heterophasic polymer represents 0 to 40% by weight of the thermoplastic material.

7. A flexible tube made of a thermoplastic material said flexible tube having at least one weld, said material being, constituted by at least one heterophasic polymer having a flexure modulus of 100 to 600 MPa according to the standard ISO 178, comprising a polymer matrix based on polypropylene and/or a copolymer of propylene, and nodules of ethylene-propylene rubber and a copolymer of propylene and butane, and optionally another α-olefin in C₂-C₈.

8. A flexible tube as claimed in claim 7, characterised in that the copolymer of propylene and butene is a terpolymer of propylene-ethylene-butene.

9. A flexible tube as claimed in claim 7, characterised in that the copolymer of propylene and butene represents from 10% to 50% by weight of the thermoplastic material.

10. A flexible tube as claimed in claim 9, characterised in that the copolymer of propylene and butene represents 15 to 33%, and preferably around 20% by weight of thermoplastic material.

11. A flexible tube as claimed in claim 7, characterised in that it comprises a mixture of a first and a second heterophasic polymers comprising each a polymer matrix based on polypropylene and/or a copolymer of propylene, and nodules of ethylene-propylene rubber:
the first heterophasic polymer having a flexure modulus of at least 300 MPa, preferably of the order of 400 MPa,
the second heterophasic polymer having a flexure modulus of 70 Pa to 100 MPa, preferably around 80 MPa.

12. A flexible tube as claimed in claim 8, characterized in that the copolymer of propylene and butane represents from 10% to 50% by weight of the thermoplastic material.

13. A flexible tube as claimed in claim 9, characterised in that it comprises a mixture of a first and a second heterophasic polymers comprising each a polymer matrix based on polypropylene and/or a copolymer of propylene, and nodules of ethylene-propylene rubber:
the first heterophasic polymer having a flexure modulus of at least 300 MPa, preferably of the order of 400 MPa,
the second heterophasic polymer having a flexure modulus of 70 Pa to 100 MPa, preferably around 80 MPa.

14. A flexible tube as claimed in claim 10, characterised in that it comprises a mixture of a first and a second heterophasic polymers comprising each a polymer matrix based on polypropylene and/or a copolymer of propylene, and nodules of ethylene-propylene rubber:
the first heterophasic polymer having a flexure modulus of at least 300 MPa, preferably of the order of 400 MPa,
the second heterophasic polymer having a flexure modulus of 70 Pa to 100 MPa, preferably around 80 MPa.

15. The thermoplastic material as claimed in claim 2, characterised in that the copolymer of propylene and butane represents from 10% to 50% by weight of the thermoplastic material.

16. A flexible tube as claimed in claim 2, characterised in that it comprises a mixture of a first and a second heterophasic polymers comprising each a polymer matrix based on polypropylene and/or a copolymer of propylene, and nodules of ethylene-propylene rubber:
the first heterophasic polymer having a flexure modulus of at least 300 MPa, preferably of the order of 400 MPa,
the second heterophasic polymer having a flexure modulus of 70 Pa to 100 MPa, preferably around 80 MPa.

17. The thermoplastic material as claimed in claim 3, characterised in that it comprises a mixture of a first and a second heterophasic polymers comprising each a polymer matrix based on polypropylene and/or a copolymer of propylene, and nodules of ethylene-propylene rubber:
the first heterophasic polymer having a flexure modulus of at least 300 MPa, preferably of the order of 400 MPa,
the second heterophasic polymer having a flexure modulus of 70 Pa to 100 MPa, preferably around 80 MPa.

18. The thermoplastic material as claimed in claim 4, characterised in that it comprises a mixture of a first and a second heterophasic polymers comprising each a polymer matrix based on polypropylene and/or a copolymer of propylene, and nodules of ethylene-propylene rubber:
the first heterophasic polymer having a flexure modulus of at least 300 MPa, preferably of the order of 400 MPa,
the second heterophasic polymer having a flexure modulus of 70 Pa to 100 MPa, preferably around 80 MPa.

19. The thermoplastic material as claimed in claim 15, characterised in that it comprises a mixture of a first and a second heterophasic polymers comprising each a polymer matrix based on polypropylene and/or a copolymer of propylene, and nodules of ethylene-propylene rubber:
the first heterophasic polymer having a flexure modulus of at least 300 MPa, preferably of the order of 400 MPa,
the second heterophasic polymer having a flexure modulus of 70 Pa to 100 MPa, preferably around 80 MPa.
